(19) United States
(12) Patent Application Publication
(10) Pub. No.: US 2011/0064952 A1
(43) Pub. Date: Mar. 17, 2011

(54) CERAMIC SUBSTRATE AND METHOD OF FABRICATING THE SAME

(75) Inventors: Min Ji Ko, Suwon (KR); Yong Seok Choi, Suwon (KR)

(73) Assignee: SAMSUNG ELECTRO-MECHANICS CO., LTD.

(21) Appl. No.: 12/650,801

(22) Filed: Dec. 31, 2009

(30) Foreign Application Priority Data
Sep. 11, 2009 (KR) 10-2009-0085931

(51) Int. Cl. B32B 18/00; B29C 65/02; B28B 1/00; B28B 3/00

(52) U.S. Cl. 428/411.1; 156/89.11

(57) ABSTRACT

A method of fabricating a ceramic substrate includes: preparing a firing theta; forming a ceramic laminated body comprising at least one internal confinement layer on the ceramic theta; providing a temperature-compensation ceramic layer on at least one of a top surface of the ceramic laminated body and a bottom surface of the ceramic laminated body contacting the firing theta, the temperature-compensation ceramic layer having a different initial firing shrinkage temperature than the ceramic laminated body; and firing the ceramic laminated body.

### CROSS-REFERENCE TO RELATED APPLICATIONS

This application claims the priority of Korean Patent Application No. 10-2009-0085931 filed on Sep. 11, 2009, in the Korean Intellectual Property Office, the disclosure of which is incorporated herein by reference.

### BACKGROUND OF THE INVENTION

1. Field of the Invention

The present invention relates to a ceramic substrate and a method of fabricating the same, and more particularly, to a ceramic substrate, capable of controlling the warpage degree of a substrate without undergoing complex processes, and a method of fabricating the same.

2. Description of the Related Art

In order to reduce manufacturing costs of circuit boards or mount chips having high precision, it is necessary to reduce the warpage of a circuit board which is caused by disparities in shrinkage behavior during a firing process.

In order to reduce the warpage of the circuit board, a firing process is performed after a non-fired ceramic layer, which is not fired at a firing temperature of a laminated body, is adhered to the laminated body. In this way, the warpage caused by a firing shrinkage of the laminated body is restricted by the non-fired ceramic layer. The circuit board is shrunk only in a thickness direction, and the non-fired ceramic layer is polished.

While the above-described method may suppress the shrinkage of the circuit board in a length direction, the process of polishing the non-fired ceramic layer is required after the completion of the firing process. Consequently, the fabrication process becomes complicated and the cost of fabrication increases.

### SUMMARY OF THE INVENTION

An aspect of the present invention provides a ceramic substrate and a method of fabricating the same, capable of controlling the warpage degree of a substrate without undergoing complex processes.

According to an aspect of the present invention, there is provided a method of fabricating a ceramic substrate, the method including: preparing a firing theta; forming a ceramic laminated body comprising at least one internal confinement layer on the ceramic theta; providing a temperature-compensation ceramic layer on at least one of a top surface of the ceramic laminated body and a bottom surface of the ceramic laminated body contacting the firing theta, the temperature-compensation ceramic layer having a different initial firing shrinkage temperature than the ceramic laminated body; and firing the ceramic laminated body.

The temperature-compensation ceramic layer may be provided on the top surface of the ceramic laminated body and have a higher initial firing shrinkage temperature than the ceramic laminated body.

The temperature-compensation ceramic layer may be provided on the bottom surface of the ceramic laminated body and have a lower initial firing shrinkage temperature than the ceramic laminated body.

The temperature-compensation ceramic layer may be provided on the bottom surface and the top surface of the ceramic laminated body, the temperature-compensation ceramic layer provided on the bottom surface of the ceramic laminated body may have a lower initial firing shrinkage temperature than the ceramic laminated body, and the temperature-compensation ceramic layer provided on the top surface of the ceramic laminated body may have a higher initial firing shrinkage temperature than the ceramic laminated body.

The firing may be simultaneously completed so that the ceramic laminated body and the temperature-compensation ceramic layer are integrally formed.

According to another aspect of the present invention, there is provided a ceramic substrate including: a ceramic laminated body including at least one internal confinement layer; and a temperature-compensation ceramic layer provided on at least one of a top surface of the ceramic laminated body and a bottom surface of the ceramic laminated body contacting the firing theta, the temperature-compensation ceramic layer having a different initial firing shrinkage temperature than the ceramic laminated body.

The temperature-compensation ceramic layer may be provided on the top surface of the ceramic laminated body and have a higher initial firing shrinkage temperature than the ceramic laminated body.

The temperature-compensation ceramic layer may be provided on the bottom surface of the ceramic laminated body and have a lower initial firing shrinkage temperature than the ceramic laminated body.

The temperature-compensation ceramic layer may be provided on the bottom surface and the top surface of the ceramic laminated body, the temperature-compensation ceramic layer provided on the bottom surface of the ceramic laminated body may have a lower initial firing shrinkage temperature than the ceramic laminated body, and the temperature-compensation ceramic layer provided on the top surface of the ceramic laminated body may have a higher initial firing shrinkage temperature than the ceramic laminated body.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1C are schematic cross-sectional views illustrating a method of fabricating a ceramic substrate according to a first embodiment of the present invention;

FIGS. 2A to 2C are schematic cross-sectional views illustrating a method of fabricating a ceramic substrate according to a second embodiment of the present invention;

FIGS. 3A to 3D are schematic cross-sectional views illustrating a method of fabricating a ceramic substrate according to a third embodiment of the present invention;

FIGS. 4A and 4B are schematic views illustrating positions of the ceramic substrate divided in order to compare the warpage degree of the ceramic substrate according to the embodiment of the present invention with the warpage degree of the related art ceramic substrate;

FIGS. 5A and 5B are graphs showing the comparison of the warpage degree between the ceramic substrate according to the embodiment of the present invention and the related art ceramic substrate in a plan view; and

FIGS. 6A and 6B are graphs showing the comparison of the warpage degree between the ceramic substrate according to the embodiment of the present invention and the related art ceramic substrate in a stereoscopic view.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

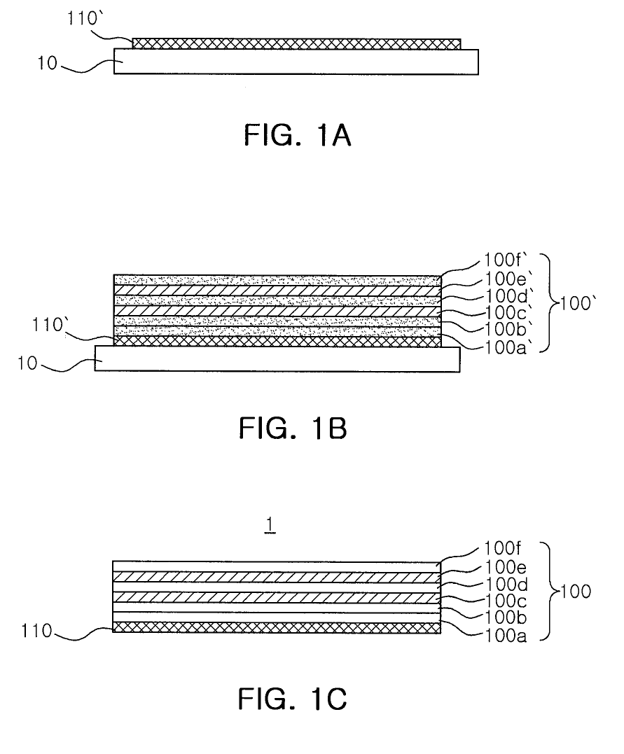

Hereinafter, methods for fabricating a ceramic substrate according to embodiments of the present invention will be described with reference to FIGS. 1A to 3D.

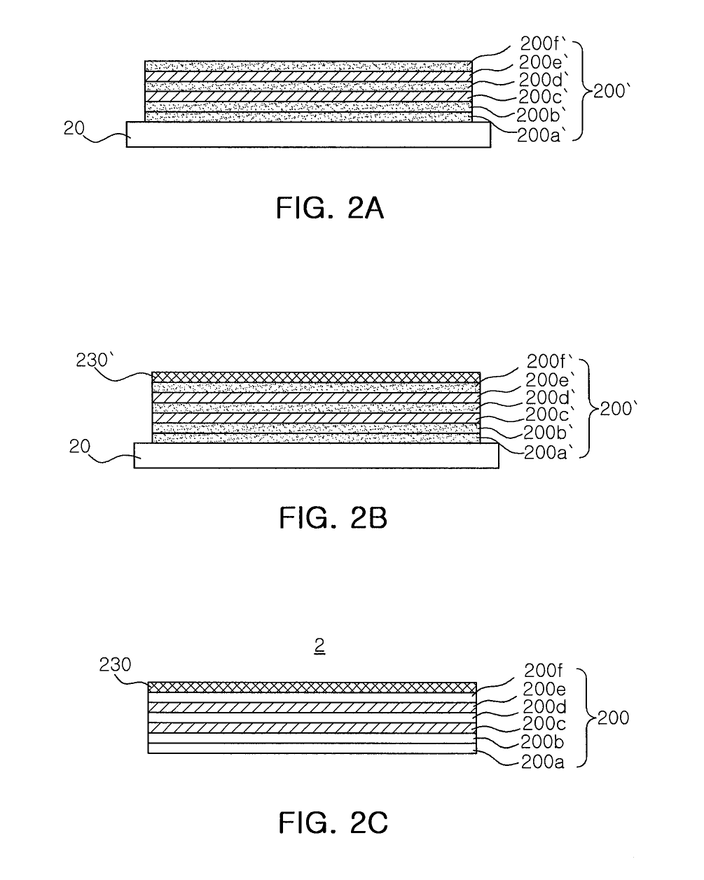

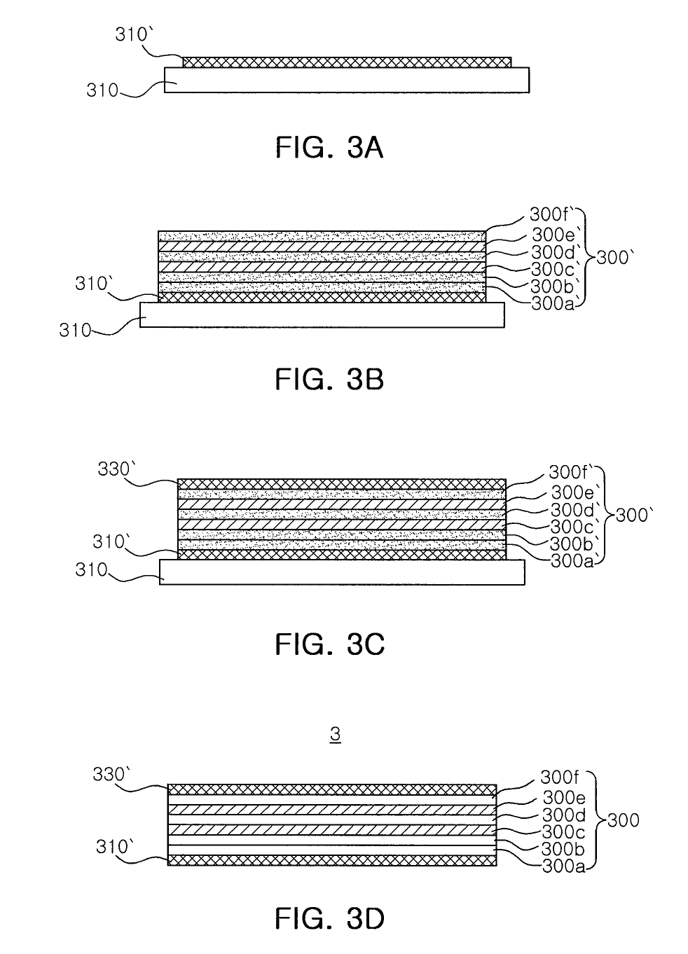

FIGS. 1A to 1C are schematic cross-sectional views illustrating a method of fabricating a ceramic substrate according to a first embodiment of the present invention. FIGS. 2A to 2C are schematic cross-sectional views illustrating a method of fabricating a ceramic substrate according to a second embodiment of the present invention. FIGS. 3A to 3D are schematic cross-sectional views illustrating a method of fabricating a ceramic substrate according to a third embodiment of the present invention.

The ceramic substrates 1, 2 and 3 according to the embodiment of the present invention include ceramic laminated bodies 100, 200 and 300, and temperature-compensation ceramic layers 110, 230, 310 and 330. The ceramic laminated bodies 100, 200 and 300 include at least one or more internal confinement layers 100c, 100e, 200c, 200e, 300c and 300e. The temperature-compensation ceramic layers 110, 230, 310 and 330 having different initial firing shrinkage temperatures from the ceramic laminated bodies 100, 200 and 300 are provided on top surfaces 100B, 200B and 300B or bottom surfaces 100A, 200A and 300A of the ceramic laminated bodies 100, 200 and 300.

The temperature-compensation ceramic layers 230 and 330 provided on the top surfaces 100B, 200B and 300B of the ceramic laminated bodies 100, 200 and 300 have higher initial firing shrinkage temperatures than those of the ceramic laminated bodies 100, 200 and 300. The temperature-compensation ceramic layers 110 and 310 provided on the bottom surfaces 100A, 200A and 300A of the ceramic laminated bodies 100, 200 and 300 have lower initial firing shrinkage temperatures than those of the ceramic laminated bodies 100, 200 and 300.

In addition, the firing is completed at the same time so that the ceramic laminated bodies 100, 200 and 300 and the temperature-compensation ceramic layers 110, 230, 310 and 330 are integrally formed.

Hereinafter, the method of fabricating the ceramic substrate according to the first embodiment of the present invention will be described in detail.

Referring to FIG. 1A, a temperature-compensation ceramic layer 110′ is formed on a firing theta 10. The temperature-compensation ceramic layer 110′ has a lower initial firing shrinkage temperature than that of a ceramic laminated body 100′ which will be subsequently formed.

Referring to FIG. 1B, a ceramic laminated body 100′, including at least one or more internal confinement layers 100c′ and 100e′ is formed on the temperature-compensation ceramic layer 110′. The ceramic laminated body 100′ where the temperature-compensation ceramic layer 110′ is formed on the bottom surface 100A is fired at a predetermined temperature.

Referring to FIG. 1C, the firing theta 10 is separated to thereby fabricate the ceramic substrate 1 according to the first embodiment of the present invention. The ceramic laminated body 100 may be smoothly polished, or may be polished to expose a connection terminal (not shown) to the outside.

Since the ceramic substrate 1 according to the first embodiment of the present invention includes the internal confinement layers 100c and 100e suppressing the length-direction shrinkage in the inside of the ceramic substrate 1 itself, a slight shrinkage is induced only in the thickness direction.

In addition, the length-direction shrinkage may be further suppressed by providing a temperature-compensation ceramic layer 110 between the firing theta 10 and the bottom surface 100A of the ceramic laminated body 100.

During the process of firing the ceramic laminated body 100, the top surface 100B of the ceramic laminated body 100 contacting hot air is in a relatively high temperature, but the bottom surface 100A of the ceramic laminated body 100 contacting the firing theta 10 is in a relatively low temperature because it is blocked from hot air by the firing theta 10. Furthermore, the middle region between the top surface 100B and the bottom surface 100A of the ceramic laminated body 100 has a middle temperature between the top surface 100B and the bottom surface 100A of the ceramic laminated body 100.

As such, in order to correct the non-uniform temperature profile of the ceramic laminated body 100, the temperature-compensation ceramic layer 110 having a lower initial firing shrinkage temperature than that of the ceramic laminated body 100 is provided between the firing theta 10 and the bottom surface 100A of the ceramic laminated body 100. In this way, the firing shrinkage of the bottom surface 100A having a relatively slow firing shrinkage may be quickly initiated. By performing the firing process after correcting the non-uniform temperature profile of the ceramic laminated body 100, the firing processes may be completed almost at the same time because the firing time difference between the top and bottom of the ceramic laminated body 100 is reduced when firing the ceramic laminated body 100 and the temperature-compensation ceramic layer 110. Therefore, the firing time is also reduced. Consequently, since the length-direction shrinkage of the ceramic laminated body 100 is further suppressed, the warpage of the ceramic substrate 1 after the firing process may be reduced.

FIGS. 2A to 2C illustrate the method of fabricating the ceramic substrate according to the second embodiment of the present invention.

Referring to FIG. 2A, a ceramic laminated body 200′ including at least one or more internal confinement layers 200c′ and 200e′ is formed on a firing theta 20.

Referring to FIG. 2B, a temperature-compensation ceramic layer 230′ is formed on the ceramic laminated body 200′. The temperature-compensation ceramic layer 230′ has a higher initial firing shrinkage temperature than that of the ceramic laminated body 200′. Then, the ceramic laminated body 200′ where the temperature-compensation ceramic layer 230′ is formed on the top surface 200B is fired at a predetermined temperature.

Referring to FIG. 2C, the firing theta 20 is separated to thereby fabricate the ceramic substrate 2 according to the second embodiment of the present invention. The ceramic laminated body 200 may be smoothly polished, or may be polished to expose a connection terminal (not shown) to the outside.

Since the ceramic substrate 2 according to the second embodiment of the present invention includes the internal confinement layers 200c and 200e suppressing the length-direction shrinkage in the inside of the ceramic substrate 2 itself, a slight amount of shrinkage is induced only in the thickness direction.

In addition, the length-direction shrinkage may be further suppressed by providing a temperature-compensation ceramic layer 230 on the top surface 200B of the ceramic laminated body 200.

During the process of firing the ceramic laminated body 200, the top surface 200B of the ceramic laminated body 200 contacting hot air has a relatively high temperature, but the bottom surface 200A of the ceramic laminated body 200 contacting the firing theta 20 has a relatively low temperature because it is blocked from hot air by the firing theta 20. Furthermore, the middle region between the top surface 200B and the bottom surface 200A of the ceramic laminated body 200 has about a middle range temperature between that of the top surface 200B and that of the bottom surface 200A of the ceramic laminated body 200.

As such, in order to correct for the non-uniform temperature profile of the ceramic laminated body 200, the temperature-compensation ceramic layer 230 having a higher initial firing shrinkage temperature than that of the ceramic laminated body 200 is provided the top surface 200B of the ceramic laminated body 200. In this way, the firing shrinkage of the bottom surface 100A having a relatively fast firing shrinkage may be slowly initiated. By performing the firing process after correcting the non-uniform temperature profile of the ceramic laminated body 200, the firing processes may be completed almost simultaneously because the firing time difference between the top and bottom of the ceramic laminated body 200 is reduced when firing the ceramic laminated body 200 and the temperature-compensation ceramic layer 230. Therefore, the firing time is also reduced. Consequently, since the length-direction shrinkage of the ceramic laminated body 200 is further suppressed, the warpage of the ceramic substrate 2 after the firing process may be reduced.

FIGS. 3A to 3D illustrate the method of fabricating the ceramic substrate according to the third embodiment of the present invention.

Referring to FIG. 3A, a temperature-compensation ceramic layer 310′ is formed on a firing theta 30. The temperature-compensation ceramic layer 310′ has a lower initial firing shrinkage temperature than that of a ceramic laminated body 300′ which will be formed later.

Referring to FIG. 3B, a ceramic laminated body 300′ including at least one or more internal confinement layers 300c′ and 300e′ is formed on the temperature-compensation ceramic layer 310′.

Referring to FIG. 3C, a temperature-compensation ceramic layer 310′ is formed on the ceramic laminated body 300′. The temperature-compensation ceramic layer 310′ has a higher initial firing shrinkage temperature than that of the ceramic laminated body 300′. Then, the ceramic laminated body 300′ where the temperature-compensation ceramic layer 310′ is formed on the firing theta 30 and the bottom surface 300A and also another temperature-compensation ceramic layer 330′ is formed on the top surface 300B is fired at a predetermined temperature.

Referring to FIG. 3D, the firing theta 30 is separated to thereby fabricate the ceramic substrate 3 according to the third embodiment of the present invention. The ceramic laminated body 300 may be smoothly polished, or may be polished to expose a connection terminal (not shown) to the outside.

Since the ceramic substrate 3 according to the third embodiment of the present invention includes the internal confinement layers 300c and 300e suppressing the length-direction shrinkage in the inside of the ceramic substrate 3 itself, a slight shrinkage is induced only in the thickness direction.

In addition, the length-direction shrinkage may be further suppressed by providing a temperature-compensation ceramic layer 310 between the firing theta 30 and the bottom surface 300A of the ceramic laminated body 300 and providing a temperature-compensation ceramic layer 330 on the top surface 300B of the ceramic laminated body 300.

During the process of firing the ceramic laminated body 300, the top surface 300B of the ceramic laminated body 300 contacting hot air has a relatively high temperature, but the bottom surface 300A of the ceramic laminated body 300 contacting the firing theta 30 has a relatively low temperature because it is blocked from hot air by the firing theta 30. Furthermore, the middle region between the top surface 300B and the bottom surface 300A of the ceramic laminated body 300 has about a middle range temperature between the top surface 300B and the bottom surface 300A of the ceramic laminated body 300.

As such, in order to correct the non-uniform temperature profile of the ceramic laminated body 300, the temperature-compensation ceramic layer 310 having a lower initial firing shrinkage temperature than that of the ceramic laminated body 300 is provided between the firing theta 30 and the bottom surface 300A of the ceramic laminated body 300, and, at the same time, the temperature-compensation ceramic layer 330 having a higher initial firing shrinkage temperature than that of the ceramic laminated body 300 is provided on the top surface 300B of the ceramic laminated body 300. In this way, the firing shrinkage of the bottom surface 300A having a relatively slow firing shrinkage may be quickly initiated, and, at the same time, the firing shrinkage of the top surface 300B having a relatively fast firing shrinkage may be slowly initiated. By performing the firing process after correcting the non-uniform temperature profile of the ceramic laminated body 300, the firing processes may be completed almost simultaneously because the firing time difference between the top and bottom of the ceramic laminated body 300 is reduced when firing the ceramic laminated body 300 and the temperature-compensation ceramic layers 310 and 330. Therefore, the firing time is also reduced. Consequently, since the length-direction shrinkage of the ceramic laminated body 300 is further suppressed, the warpage of the ceramic substrate 3 after the firing process may be reduced.

The warpage degree of the ceramic substrate 1 fabricated by the method according to the first embodiment of the present invention will be described in comparison with the warpage degree of the related art ceramic substrate.

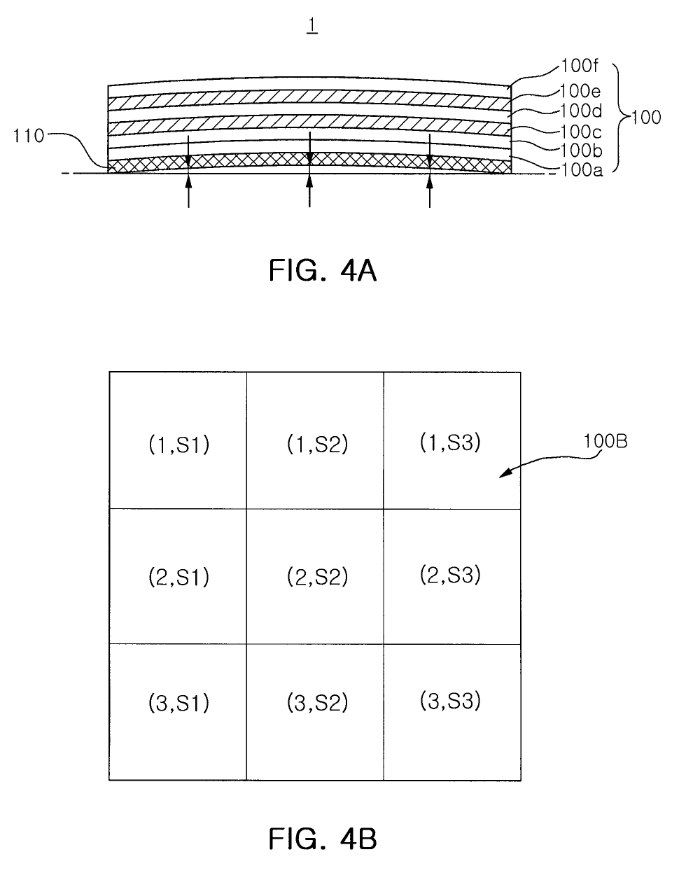

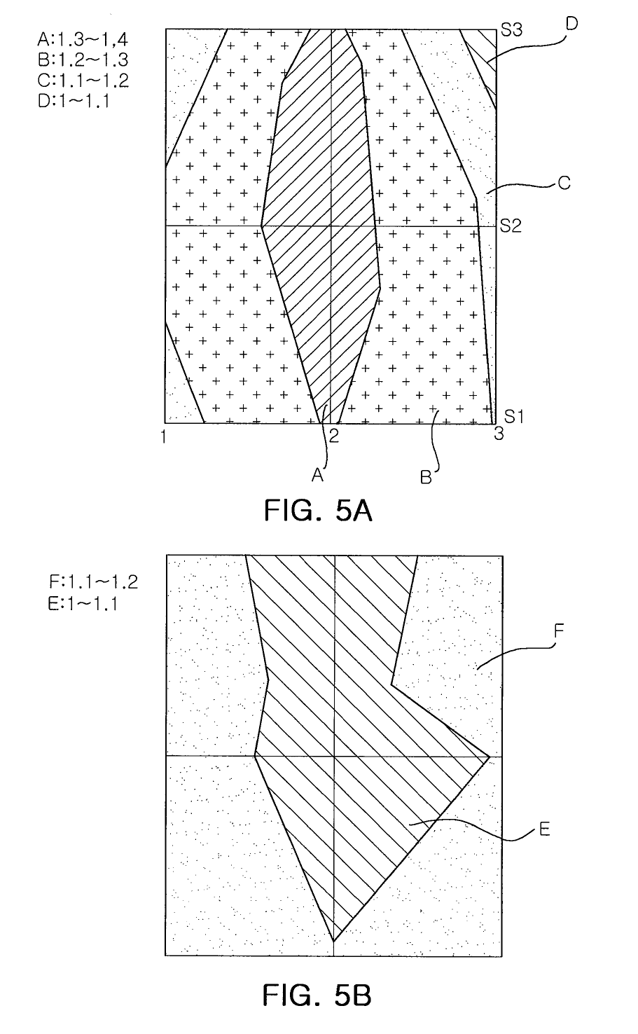

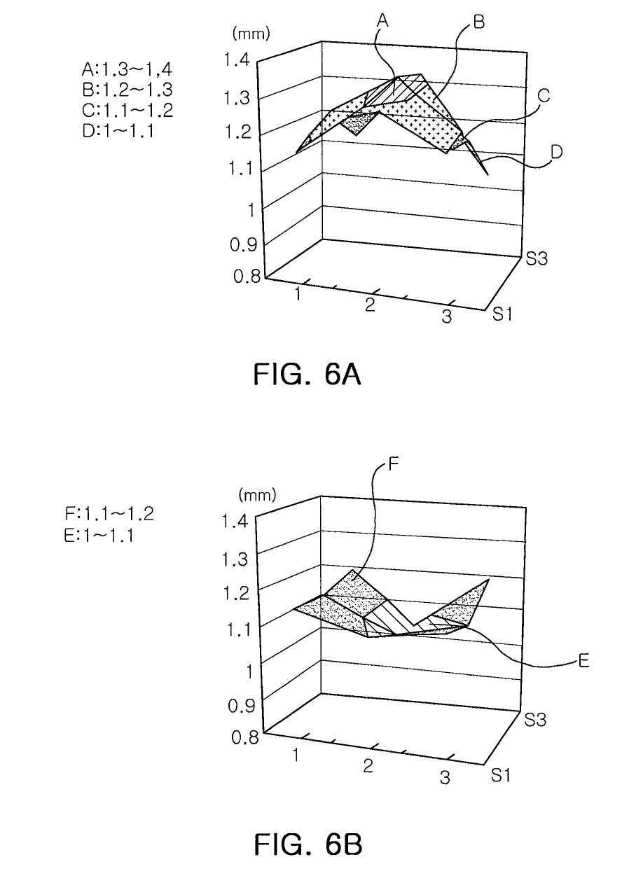

FIGS. 4A and 4B are schematic views illustrating positions of the ceramic substrate divided in order to compare the warpage degree of the ceramic substrate according to the embodiment of the present invention with the warpage degree of the related art ceramic substrate. FIGS. 5A and 5B are graphs showing the comparison of the warpage degree between the ceramic substrate according to the embodiment of the present invention and the related art ceramic substrate in a plan view. FIGS. 6A and 6B are graphs showing the comparison of the warpage degree between the ceramic substrate according to the embodiment of the present invention and the related art ceramic substrate in a stereoscopic view.

Referring to FIG. 4A, sections indicated by arrows represent the warpage degree of the ceramic substrate 1 from the ground. The warpage degree of the ceramic substrate 1 is equal to a value obtained by subtracting the thickness of the ceramic substrate 1 from the highest portion of the ceramic substrate 1, as indicated by the arrows.

FIG. 4B illustrates the top surface 100B of the ceramic substrate 1 which is divided into several regions in order to compare the warpage degree of the ceramic substrate 1 according to the first embodiment of the present invention with the related art ceramic substrate.

FIG. 5A is a graph showing the warpage degree of each position of the related art ceramic substrate in a plan view, and FIG. 5B is a graph showing the warpage degree of each position of the ceramic substrate 1 according to the first embodiment of the present invention in a plan view.

As the position varies from region D to region A of FIG. 5A, that is, as the position is closer to the center region of the ceramic substrate, the warpage degree of the ceramic substrate gradually increases and has an upwardly convex shape (see FIG. 6A). The warpage degree (mm) of each position of the ceramic substrate 1 in the schematic view of FIG. 4A is shown in Table 1 below.

TABLE 1

| | S1 | S2 | S3 |
|---|---|---|---|
| 1 | 1.167 | 1.308 | 1.199 |
| 2 | 1.232 | 1.346 | 1.184 |
| 3 | 1.125 | 1.327 | 1.040 |

FIG. 5B is a graph showing the warpage degree of each position of the ceramic substrate 1 according to the first embodiment of the present invention, which includes the temperature-compensation ceramic layer 110 between the bottom surface 100A having the initial firing shrinkage temperature of 760° C. and the firing theta 10. The initial firing shrinkage temperature of the temperature-compensation ceramic layer 100 is 670° C., which is lower than that of the ceramic laminated body 100. As the position varies from the region E to the region F, that is, the position is nearer to the center region of the ceramic substrate 1, the warpage degree of the ceramic substrate 1 increases and has an upwardly concave shape (see FIG. 6B). The warpage degree (mm) of each position of the ceramic substrate 1 in the schematic view of FIG. 4A is shown in Table 2 below.

TABLE 2

| | S1 | S2 | S3 |
|---|---|---|---|
| 1 | 1.162 | 1.103 | 1.134 |
| 2 | 1.153 | 1.053 | 1.103 |
| 3 | 1.178 | 1.018 | 1.183 |

As can be seen from the above result, unlike the related art ceramic substrate, the ceramic substrate 1 fabricated by firing after providing the temperature-compensation ceramic layer 110 having a lower initial firing shrinkage temperature than that of the ceramic laminated body 100 between the firing theta 10 and the ceramic laminated body 100 has an upwardly concave shape. The upwardly concave shape of the ceramic substrate 1 according to the embodiment of the present invention is opposite to the upwardly convex shape of the related art ceramic substrate. As can be seen from the above result, when the temperature-compensation ceramic layers 110, 230, 310 and 330 having different initial firing shrinkage temperatures from the ceramic laminated bodies 100, 200 and 300 according to the embodiments of the present invention are applied to the firing process, the shape and the warpage degree of the ceramic substrate 1 may be controlled according to a user's preference. Furthermore, the warpage degree of the ceramic substrate 1 is markedly reduced when compared with the related art ceramic substrate.

In the ceramic substrates 1, 2 and 3 fabricated according to the embodiments of the present invention, it is unnecessary to remove the temperature-compensation ceramic layers 110, 230, 310 and 330 because they become parts of the ceramic substrates 1, 2 and 3, respectively. Furthermore, since the warpage of the ceramic substrates 1, 2 and 3 is markedly reduced when compared with the related art ceramic substrate, an additional polishing process of making the surfaces of the ceramic substrates 1, 2 and 3 flat and smooth may be omitted.

As the size of the substrate is larger, the warpage of the substrate becomes more serious. If the temperature-compensation ceramic layers according to the embodiments of the present invention are used appropriately, the warpage degree of the substrate may be controlled without undergoing complex processes.

As set forth above, according to exemplary embodiments of the invention, the ceramic substrate and the method of fabricating the same are capable of controlling the warpage degree of the substrate without undergoing complex processes.

Furthermore, since the warpage degree of the ceramic substrate is further reduced than the related art ceramic substrate, it is unnecessary to perform an additional polishing process of making the surface of the ceramic substrate flat and smooth.

Moreover, since the temperature-compensation ceramic layer of the ceramic substrate is a part of the ceramic substrate, it is unnecessary to remove the temperature-compensation ceramic layer after the firing process.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of fabricating a ceramic substrate, the method comprising:
preparing a firing theta;
forming a ceramic laminated body comprising at least one internal confinement layer on the ceramic theta;
providing a temperature-compensation ceramic layer on at least one of a top surface of the ceramic laminated body and a bottom surface of the ceramic laminated body contacting the firing theta, the temperature-compensation ceramic layer having a different initial firing shrinkage temperature than the ceramic laminated body; and
firing the ceramic laminated body.

2. The method of claim 1, wherein the temperature-compensation ceramic layer is provided on the top surface of the ceramic laminated body and has a higher initial firing shrinkage temperature than the ceramic laminated body.

3. The method of claim 1, wherein the temperature-compensation ceramic layer is provided on the bottom surface of the ceramic laminated body and has a lower initial firing shrinkage temperature than the ceramic laminated body.

4. The method of claim 1, wherein the temperature-compensation ceramic layer is provided on the bottom surface and the top surface of the ceramic laminated body,
the temperature-compensation ceramic layer provided on the bottom surface of the ceramic laminated body has a lower initial firing shrinkage temperature than the ceramic laminated body, and
the temperature-compensation ceramic layer provided on the top surface of the ceramic laminated body has a higher initial firing shrinkage temperature than the ceramic laminated body.

5. The method of claim 1, wherein the firing is simultaneously completed so that the ceramic laminated body and the temperature-compensation ceramic layer are integrally formed.

6. A ceramic substrate comprising:
a ceramic laminated body comprising at least one internal confinement layer; and
a temperature-compensation ceramic layer provided on at least one of a top surface of the ceramic laminated body and a bottom surface of the ceramic laminated body contacting the firing theta, the temperature-compensation ceramic layer having a different initial firing shrinkage temperature than the ceramic laminated body.

7. The ceramic substrate of claim 6, wherein the temperature-compensation ceramic layer is provided on the top surface of the ceramic laminated body and has a higher initial firing shrinkage temperature than the ceramic laminated body.

8. The ceramic substrate of claim 6, wherein the temperature-compensation ceramic layer is provided on the bottom surface of the ceramic laminated body and has a lower initial firing shrinkage temperature than the ceramic laminated body.

9. The method of claim 6, wherein the temperature-compensation ceramic layer is provided on the bottom surface and the top surface of the ceramic laminated body,
the temperature-compensation ceramic layer provided on the bottom surface of the ceramic laminated body has a lower initial firing shrinkage temperature than the ceramic laminated body, and
the temperature-compensation ceramic layer provided on the top surface of the ceramic laminated body has a higher initial firing shrinkage temperature than the ceramic laminated body.
